(19) United States
(12) Patent Application Publication
(10) Pub. No.: US 2026/0111158 A1
(43) Pub. Date: Apr. 23, 2026

(54) STORAGE MEDIUM AND INFORMATION PROCESSING APPARATUS

(71) Applicant: CANON KABUSHIKI KAISHA, Tokyo (JP)

(72) Inventors: KOHEI TODA, Kanagawa (JP); HIROFUMI MOCHIZUKI, Saitama (JP)

(21) Appl. No.: 19/361,769

(22) Filed: Oct. 17, 2025

(30) Foreign Application Priority Data
Oct. 22, 2024 (JP) 2024-186259

(51) Int. Cl. G06F 3/12; H04N 1/00

(52) U.S. Cl. CPC G06F 3/1231; G06F 3/1208; H04N 1/0044

(57) ABSTRACT

An information processing apparatus performs an information processing method including displaying identification information associated with an object when the object included in data is selected by a user, and accepting a character string in natural language from the user, wherein processing based on a prompt including the identification information and the accepted character string in natural language is executed on the selected object by generative artificial intelligence (AI).

### BACKGROUND

### Field of the Technology

The present disclosure relates to a storage medium and an information processing apparatus.

### Description of the Related Art

Various services that use conversational artificial intelligence (AI) such as a chatbot and generative AI have been developed. Japanese Patent Laid-Open No. 2024-25293 describes a system which displays a preview image of an automobile on a display, allows the user to input, to generative AI via a chat, an instruction (prompt) in natural language for changing a body color and displays an edited preview image of the automobile.

The user has to express editing target objects included in data such as images and text boxes with a character string in natural language to issue an instruction to edit data when the user instructs generative AI to edit data. Therefore, if the user cannot express the editing target with a character string in natural language, it will be difficult to issue an instruction to edit data.

### SUMMARY

According to an aspect of the present disclosure, there is provide a non-transitory computer-readable storage medium for storing a computer program that, when executed by one or more processors of an information processing apparatus causes the information processing apparatus to execute a method including displaying identification information associated with an object when the object included in data is selected by a user; and accepting a character string in natural language from the user, wherein processing based on a prompt including the identification information and the accepted character string in natural language is executed on the selected object by generative artificial intelligence (AI).

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a general configuration of the present system.

FIG. 2 is a block diagram illustrating an example of a hardware configuration of a computer included in the present system.

FIG. 3 is a block diagram illustrating an example of a hardware configuration of a generative artificial intelligence (AI) server included in the present system.

FIG. 4 is a block diagram illustrating an example of a hardware configuration of a printer included in the present system.

FIG. 5 is a block diagram illustrating an example of a software configuration of the present system.

FIG. 6 is a diagram illustrating an example of a printing application screen displayed in the present system.

FIG. 7 is a diagram illustrating an example of the printing application screen when an image is selected from a preview area of the printing application screen.

FIG. 8 is a diagram illustrating an example of the printing application screen when conversion processing is executed after the image is selected from the preview area of the printing application screen.

FIG. 9 is a diagram illustrating an example of the printing application screen when an area is manually selected from the preview area of the printing application screen.

FIG. 10 is a diagram illustrating an example of the printing application screen when conversion processing is executed after the area is manually selected from the preview area of the printing application screen.

FIGS. 11A and 11B is a sequence diagram illustrating an example of image conversion processing using a chat and printing processing in the present system.

FIG. 12 is a flowchart illustrating an example of object recognition processing in the present system.

FIG. 13 is a diagram illustrating an example of a result of the object recognition processing in the present system.

FIG. 14 is a table illustrating an example of a structure of history data in the present system.

### DESCRIPTION OF THE EMBODIMENTS

Hereinafter, embodiments are described in detail with reference to the appended drawings. The below-described embodiments are not intended to limit the present disclosure according to the scope of the appended claims. Although a plurality of features is described in the embodiments, not all of the features are essentially required for the present disclosure, and the plurality of features may be optionally combined. Further, in the appended drawings, same reference numerals are applied to constituent elements identical or similar to each other, and duplicative descriptions are omitted.

### Embodiments

### System Configuration

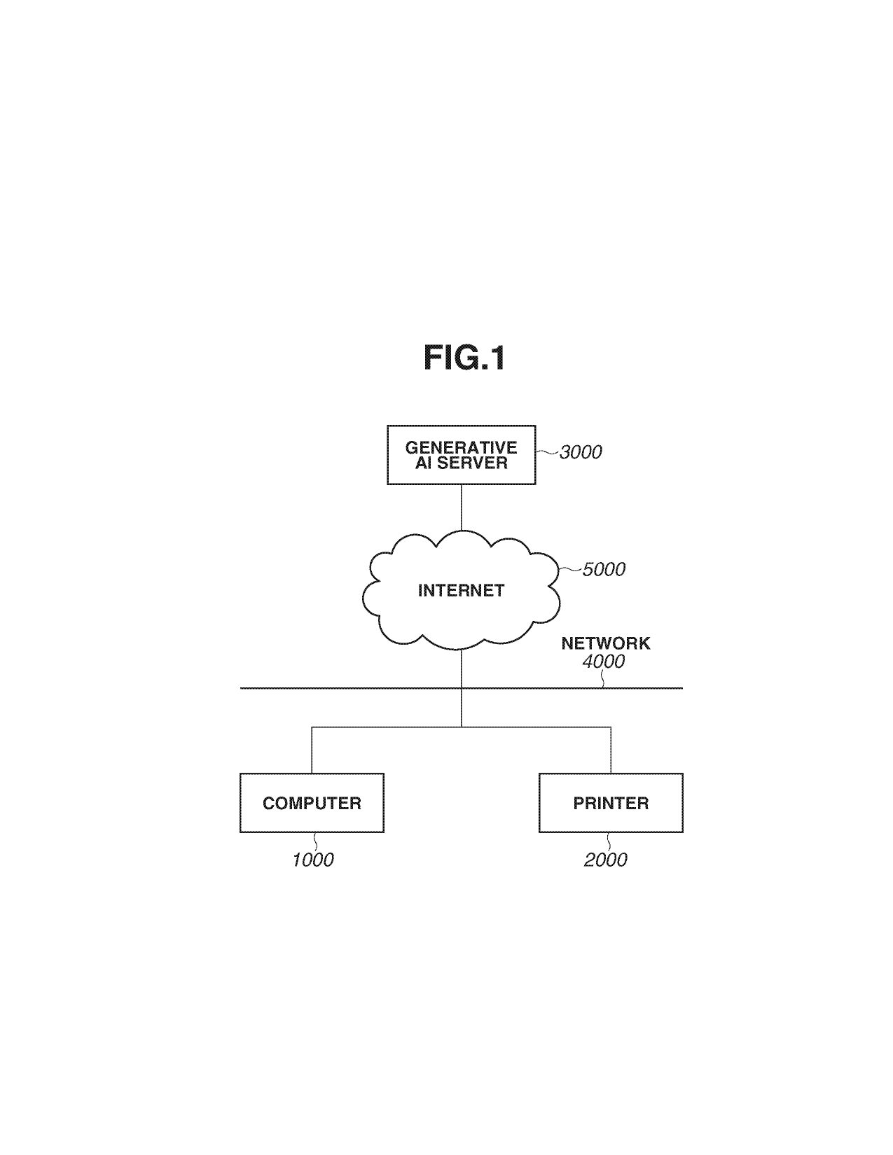

Hereinafter, a first embodiment of the present disclosure is described. First, a network configuration of a printing system according to the present embodiment is described with reference to FIG. 1.

As illustrated in FIG. 1, the printing system includes a computer 1000 as a terminal apparatus, a printer 2000 capable of executing printing, and a generative artificial intelligence (AI) server 3000.

For example, the computer 1000 and the printer 2000 are installed in the office, and communicably connected to each other via a network 4000. The network 4000 is connected to the external internet 5000 via a router (not illustrated). With this configuration, the generative AI server 3000 connected to the internet 5000, the computer 1000, and the printer 2000 are communicably connected to each other.

The computer 1000 is an example of an information processing apparatus, a user terminal, or a terminal apparatus. The printer 2000 is an example of an image processing apparatus, an image forming apparatus, or a multi function peripheral (MFP). The generative AI server 3000 is an example of an information processing apparatus. The generative AI server 3000 provides a generative AI service 3100. Further, a printing application 1100 described below is executed and provided by the computer 1000 or the printer 2000.

### Hardware Configuration

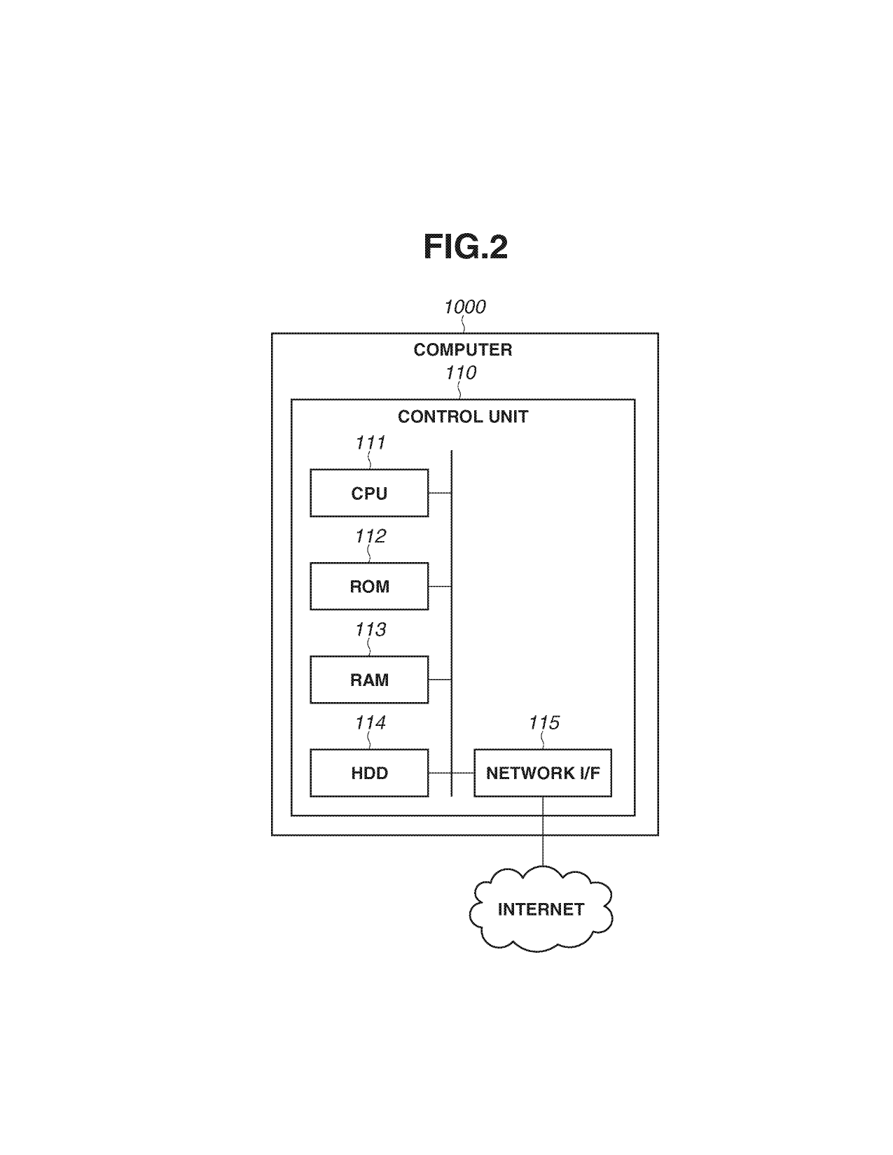

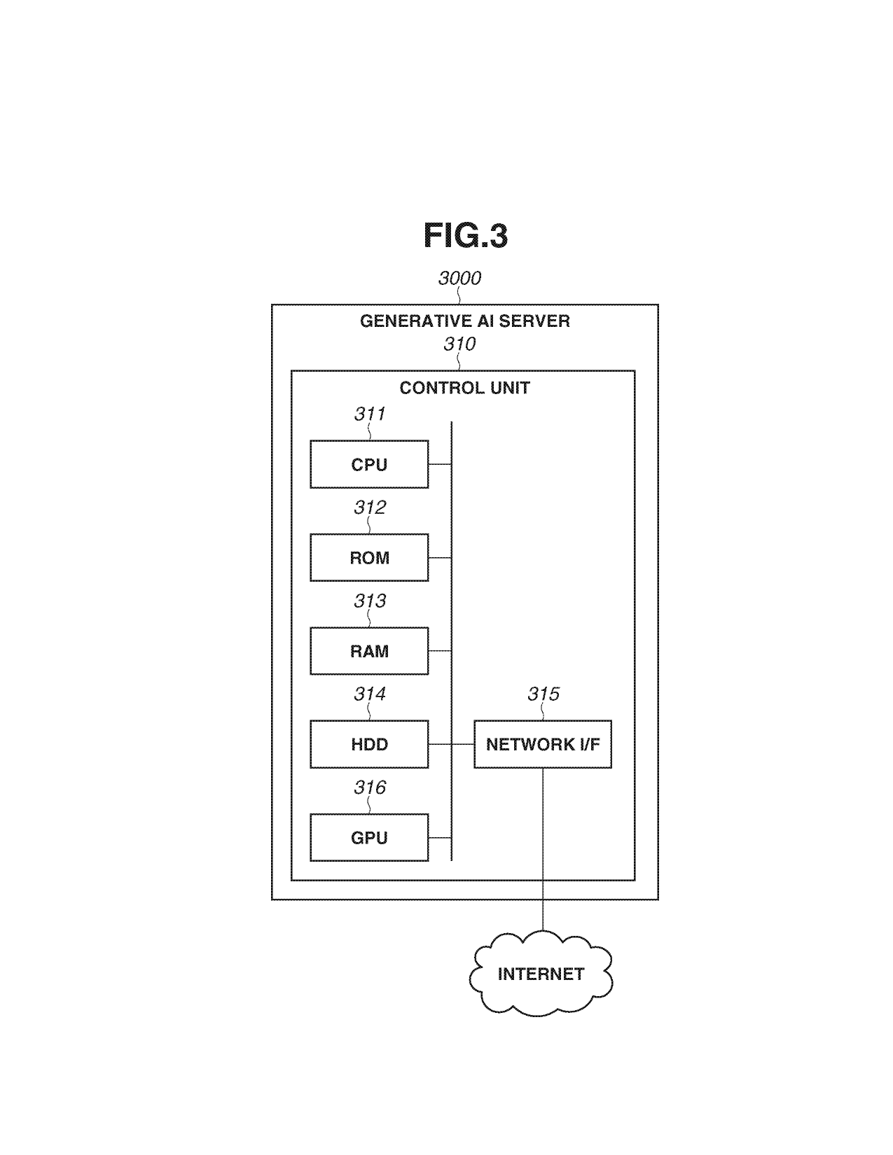

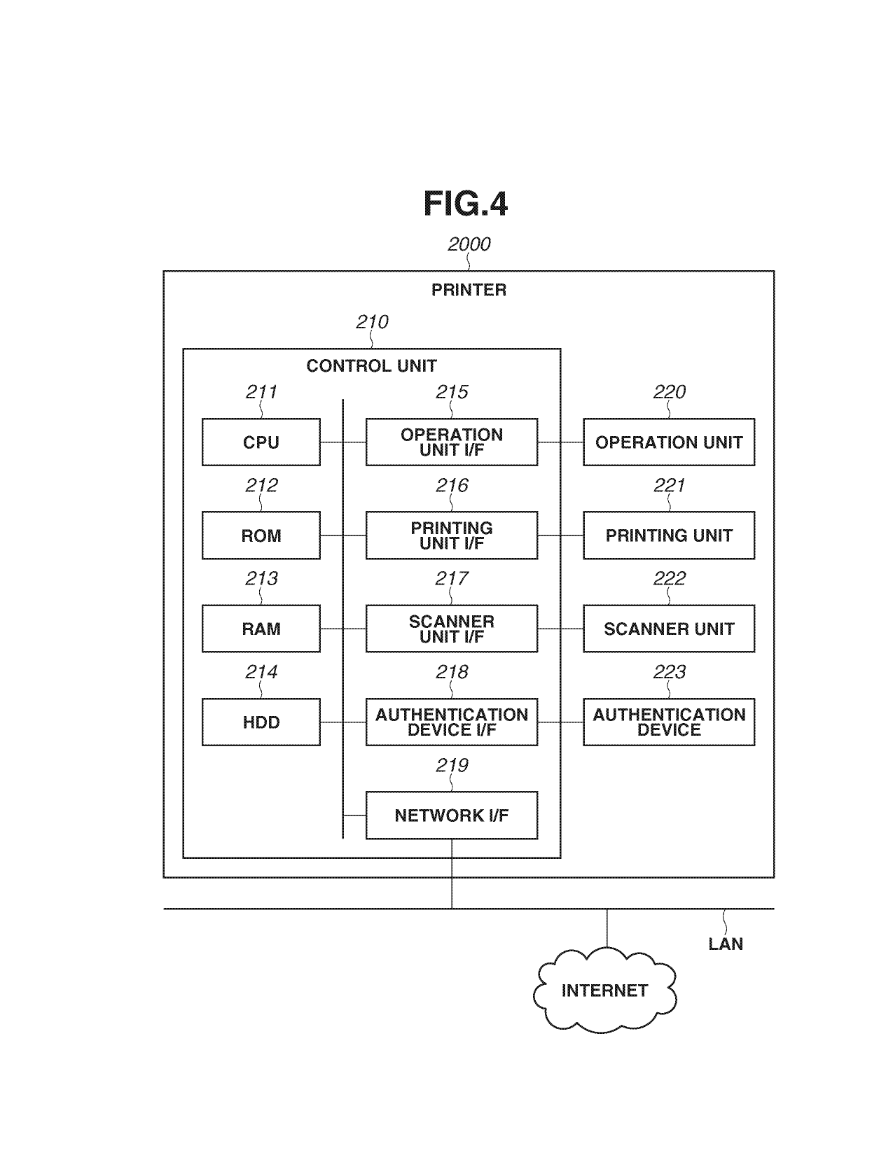

Examples of hardware configurations of respective apparatuses which constitute the printing system according to the present embodiment are described with reference to FIGS. 2, 3, and 4. FIG. 2 illustrates an example of the hardware configuration of the computer 1000. FIG. 3 illustrates an example of the hardware configuration of the generative AI server 3000. FIG. 4 illustrates an example of the hardware configuration of the printer 2000.

As illustrated in FIG. 2, the computer 1000 includes a central processing unit (CPU) 111, a read only memory (ROM) 112, a random access memory (RAM) 113, a hard disk drive (HDD) 114, and a network interface (I/F) 115.

The CPU 111 controls an overall operation by reading a control program stored in the ROM 112 or the HDD 114 and executing various types of processing. The RAM 113 is used as a main memory and a temporary storage area such as a working area of the CPU 111. The HDD 114 is a large-capacity storage unit for storing image data and various programs. The network I/F 115 is an interface for connecting the computer 1000 to the internet. The computer 1000 receives processing requests from the other apparatus and a service and transmits and receives various types of information via the network I/F 115. The computer 1000 described in the present embodiment further includes an operation unit (display unit) which is not illustrated.

As illustrated in FIG. 3, the hardware configuration of the generative AI server 3000 is substantially similar to the hardware configuration of the computer 1000. Therefore, in the present embodiment, description is omitted with respect to the hardware configuration of the generative AI server 3000. In addition, a graphics processing unit (GPU) 316 serving as a calculation unit, which includes an image processing processor, can be included in the generative AI server 3000.

As illustrated in FIG. 4, the printer 2000 includes a control unit 210, an operation unit 220, a printing unit 221, a scanner unit 222, and an authentication device 223. The control unit 210 includes the below-described units 211 to 219, and controls an overall operation of the printer 2000. The CPU 211 executes and controls various functions such as reading, printing, and communication functions included in the printer 2000 by reading a control program stored in the ROM 212. The RAM 213 is used as a main memory and a temporary storage area such as a working area of the CPU 211.

In the present embodiment, the one CPU 211 executes the processing illustrated in the below-described flowcharts by using one memory, i.e., the RAM 213 or the HDD 214. However, the present embodiment is not limited to the above. For example, a plurality of CPUs and a plurality of RAMs or HDDs may cooperatively execute the processing.

The HDD 214 is a large-capacity storage unit for storing image data and various programs. An operation unit I/F 215 is an interface for connecting the operation unit 220 to the control unit 210. The operation unit 220 includes a touch panel and a keyboard, and accepts an operation, an input, and an instruction from the user. A printing unit I/F 216 is an interface for connecting the printing unit 221 to the control unit 210. Image data used for printing is transmitted to the printing unit 221 from the control unit 210 via the printing unit I/F 216 and printed on a recording medium.

A scanner unit I/F 217 is an interface for connecting the scanner unit 222 to the control unit 210. The scanner unit 222 generates image data by reading a document placed on a document positioning plate or an auto document feeder (ADF) (not illustrated), and inputs the image data to the control unit 210 via the scanner unit I/F 217.

The printer 2000 can print and output (i.e., copy) the image data generated by the scanner unit 222 through the printing unit 221, and can also transmit the image data through file transmission or mail transmission. An authentication device I/F 218 is an interface for connecting the authentication device 223 to the control unit 210.

For example, the authentication device 223 is a card reader for reading an integrated circuit (IC) card or a fingerprint authentication device for reading a fingerprint. The authentication device 223 is used when the user performs authentication in order to use the printer 2000.

A network I/F 219 is an interface for connecting the control unit 210 (printer 2000) to a local area network (LAN). The printer 2000 transmits image data and information to the services connected to the internet, and receives various types of information via the network I/F 219. The operation unit 220 is an interface which includes a touch panel and a keyboard. The operation unit 220 displays information to the user, and accepts an input from the user.

### Software Configuration

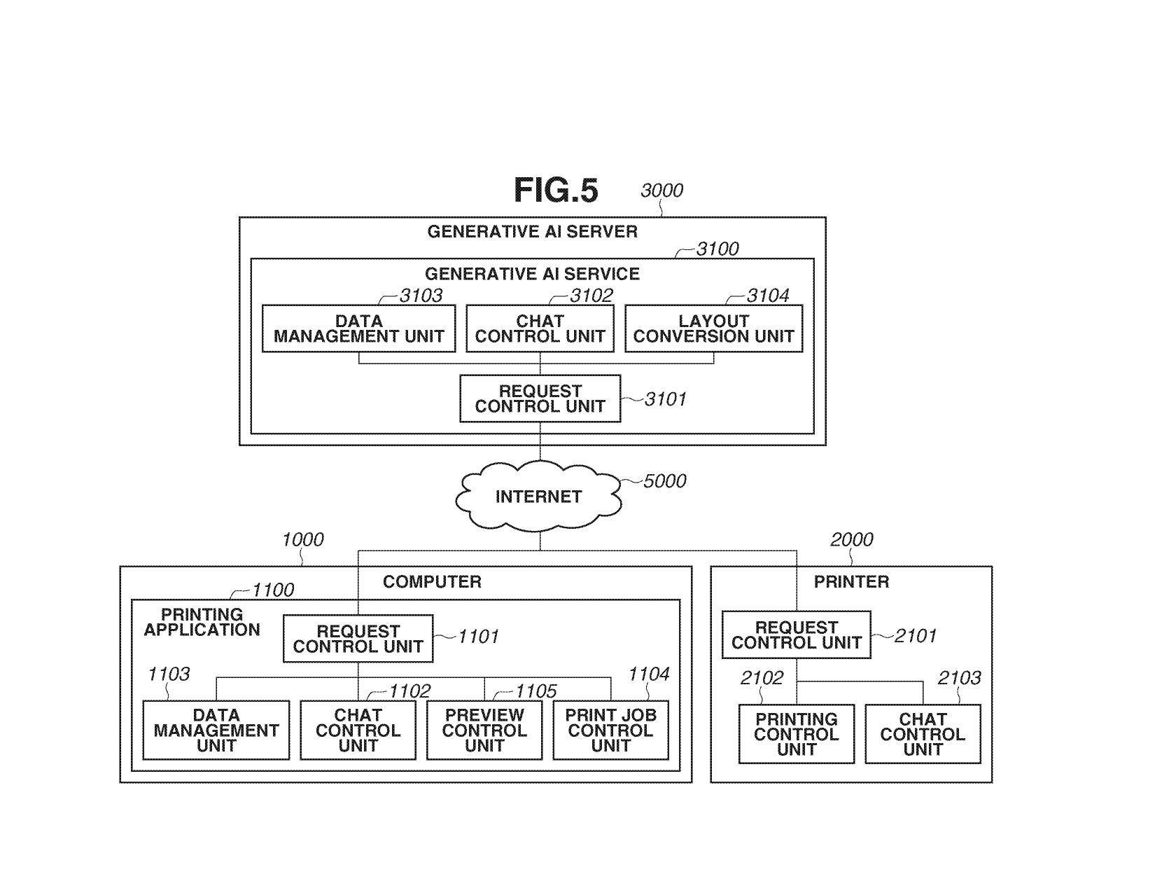

Software configurations of apparatuses included in the printing system according to the present embodiment are described with reference to FIG. 5.

As illustrated in FIG. 5, the computer 1000 includes a printing application 1100. The printing application 1100 displays a preview image of print data, changes a print setting, and transmits a print job to the printer 2000. The printing application 1100 can be an application provided independently of an operating system (OS), or an application integrated with a printer driver application embedded in the OS.

The printing application 1100 includes a request control unit 1101, a chat control unit 1102, a data management unit 1103, and a print job control unit 1104.

The request control unit 1101 stands ready to receive requests from the computer 1000, the printer 2000, and the generative AI server 3000, and causes the units included in the printing application 1100 to execute processing according to the requests.

The chat control unit 1102 transmits a prompt and print data input by the user to the generative AI server 3000. Further, the chat control unit 1102 displays data received from the generative AI server 3000.

The data management unit 1103 manages data used by the printing application 1100. For example, a prompt input to the chat control unit 1102, print data before conversion which is to be transmitted to the generative AI service 3100, print data after conversion which is received from the generative AI service 3100, and information acquired from the print data are managed as the above data. Further, an application setting used by the printing application 1100 is also saved and managed.

The print job control unit 1104 converts print data generated by the printing application 1100 and the generative AI server 3000 into data in a format printable by the printer 2000, and transmits the converted data to the printer 2000 as a print job. In addition, the print data can be a data in a format directly printable by the printer 2000 without being converted by the print job control unit 1104. The preview control unit 1105 displays received print data and data received from the generative AI server 3000.

The printer 2000 includes a request control unit 2101, a printing control unit 2102, and a chat control unit 2103. The request control unit 2101 stands ready to receive requests from the computer 1000, the printer 2000, and the generative AI server 3000.

The printing control unit 2102 executes printing of a print job received from the computer 1000. Specifically, the printing control unit 2102 prints an image based on the image data included in the received print job on a printing medium such as a sheet of paper. The printer 2000 may promptly print the received print job without accepting an instruction from the user, or may hold the print job until a printing instruction is issued by the user and execute printing after the printing instruction is issued by the user.

The chat control unit 2103 transmits a prompt and print data input by the user to the generative AI server 3000. Further, the chat control unit 2103 displays data received from the generative AI server 3000.

The generative AI server 3000 provides the generative AI service 3100. The generative AI service 3100 includes a request control unit 3101, a chat control unit 3102, a data management unit 3103, and a layout conversion unit 3104. In the present embodiment, a prompt is a character string in natural language describing an instruction, by which the user instructs the generative AI server 3000 to execute processing through a generative AI function.

The request control unit 3101 has a function for executing interpretation processing through generative AI and a function for modifying a layout of print data. The request control unit 3101 stands ready to receive requests from the computer 1000, the printer 2000, and the generative AI server 3000, and causes the units included in the generative AI service 3100 to execute processing according to the requests.

The chat control unit 3102 has a function for executing interpretation processing through generative AI. The chat control unit 3102 interprets a received prompt described in natural language and received print data, and determines a response to the prompt and layout conversion processing to be executed on the print data.

The layout conversion unit 3104 receives the layout conversion processing to be executed on the print data interpreted by the chat control unit 3102, and executes the layout conversion processing. In other words, the layout conversion unit 3104 executes the conversion processing by receiving the character string in natural language. As described below, because the character string in natural language specifies a processing target, the layout conversion unit 3104 executes the processing on the processing target based on the received character string in natural language.

The layout conversion unit 3104 further executes object recognition processing for recognizing the object included in the print data. In the present embodiment, the chat control unit 3102 and the layout conversion unit 3104 are described as different processing units. However, the chat control unit 3102 and the layout conversion unit 3104 may be provided as one conversion processing unit to execute the processing.

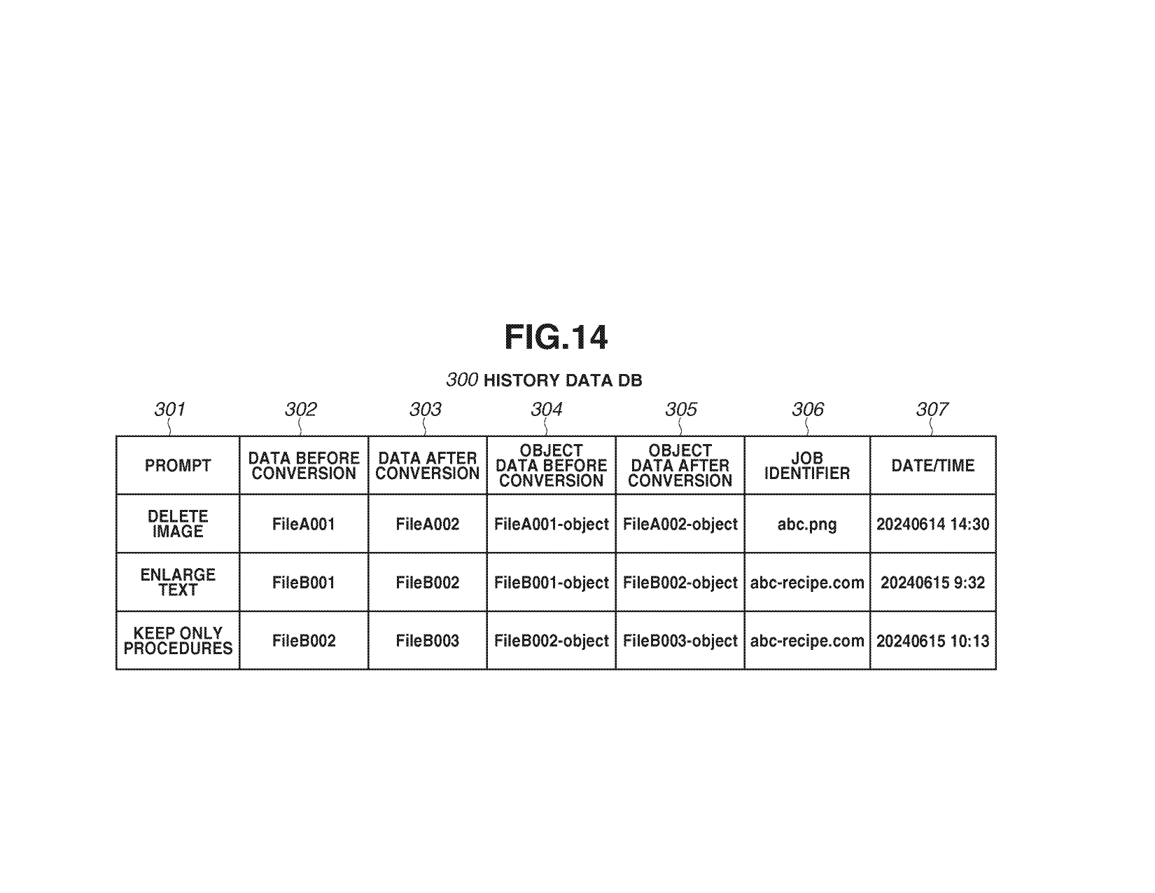

The data management unit 3103 saves and manages a history of the received prompt, the received print data, and the converted print data in association with information for specifying the user who has issued the instruction. An example of the history data saved by the data management unit 3103 is described below with reference to FIG. 14.

### Example of Printing Application Screen

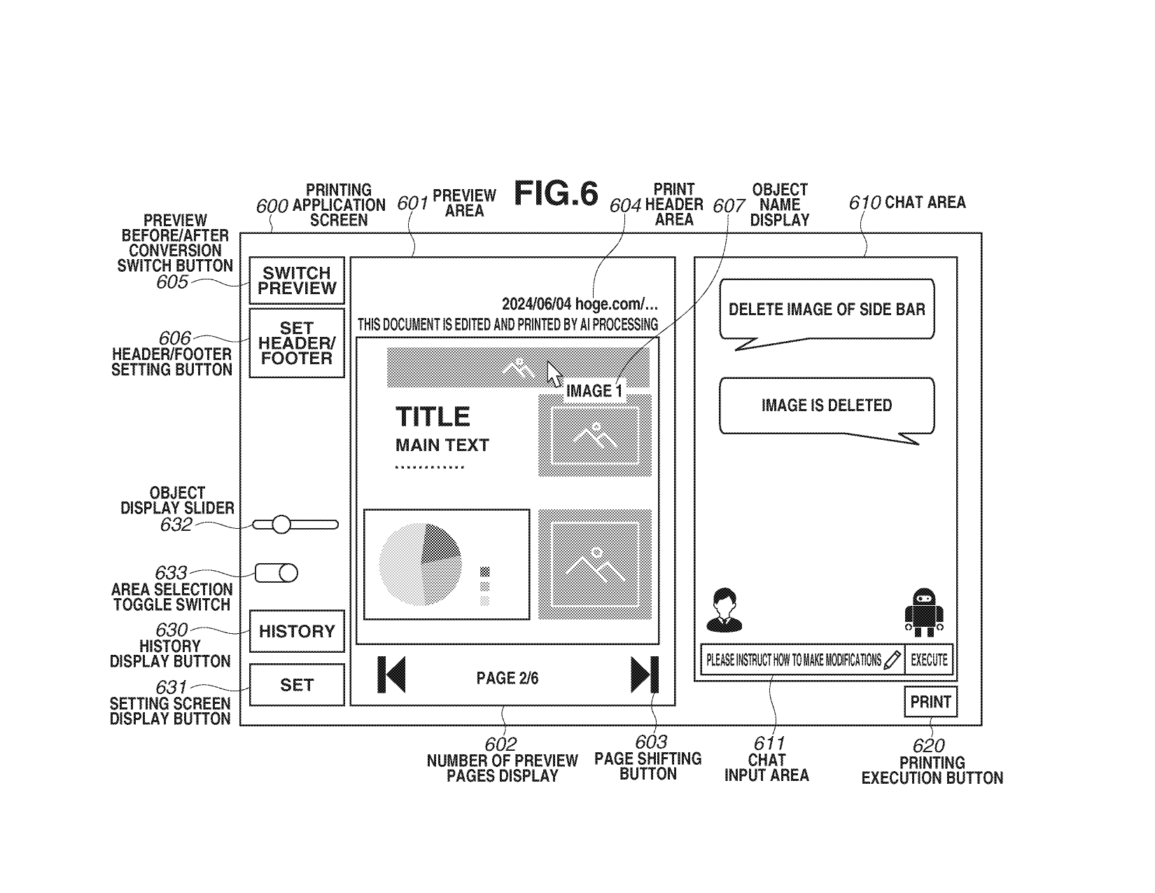

A printing application screen 600 displayed on the computer 1000 or the printer 2000 is described with reference to FIG. 6. The printing application screen 600 includes a preview area 601, a chat area 610, and other controls. The printing application screen 600 is one example of screens provided by the printing application 1100.

The preview area 601 displays a preview image of print data which is to be printed based on an instruction issued by the printing application 1100. Objects such as images, diagrams, and text, included in the print data displayed in the preview area 601 can be selected by a mouse cursor. When the user selects an object, a name of the selected object is input to a chat input area 611. In other words, when an object is selected, a character string in natural language associated with the selected object is specified and displayed in the chat input area 611.

In addition, the user can freely select an area. An example of the screen when the user has selected the area is described below. Further, an object selected by the operation called "mouseover" is highlighted and displayed together with an object name. Herein, "mouseover" refers to the operation for putting a mouse cursor over the object. An object name display 607 illustrates an example of an object name "Image 1" displayed when a mouse cursor is put over an image in the upper part of the preview area 601. Details of the processing related to the object is described below.

By displaying a preview image of the print data, the user is allowed to check the printed matter to be printed by the printer 2000 and also allowed to select the object and/or the area the user would like to modify before the printed matter is output.

Communication between the generative AI and the user is displayed in the chat area 610 in a chat format.

Specifically, a character string (i.e., prompt) in natural language input by the user and a response to that character string transmitted by the generative AI are displayed. Pieces of information displayed in the preview area 601 and the chat area 610 are updated every time the response from the generative AI server 3000 is received. Further, in a case where processing cannot be specified by the prompt input by the user, the generative AI may display an inquiry to the user or an error message without executing processing on the print data. In this case, updating of the preview area 601 is not essentially required.

As described above, the printing application screen 600 is displayed on the operation unit (not illustrated) of the computer 1000 or the printer 2000. Hereinafter, the printing application screen 600 displayed on the operation unit of the computer 1000 is described as an example.

In the present embodiment, first, a preview image of print data such as a file or a web site is displayed in the preview area 601. Next, the user inputs a character string describing a layout conversion instruction of the print data in natural language to the chat input area 611. A preview image of data converted by the generative AI server 3000 through the conversion processing based on the layout conversion instruction is displayed in the preview area 601, so that the screen is updated.

The preview area 601 includes a number of preview pages display 602, a page shifting button 603, a print header area 604, a preview before/after conversion switch button 605, and a header/footer setting button 606.

The total number of pages when the print data is printed and a preview page number (page count) of the existing image displayed in the preview area 601 are displayed in the number of preview pages display 602. When the page shifting button 603 is pressed, the existing displayed preview page number is shifted to a previous page number or to a next page number, and a preview page displayed in the preview area 601 is changed accordingly.

A preview of a header to be printed when printing the print data is displayed in the print header area 604. A printed date/time and a printing target name such as a file name or a uniform resource locator (URL) of the printing target can be included in the header. Further, in a case where the print data is edited by the generative AI service 3100 when a setting for printing a character string describing use of generative AI for editing work is enabled, a character string describing use of generative AI for editing work of the printed matter can be included in the header. In addition, this character string may be previewed and printed in a print footer area or other blank space of the print data, or may be previewed and printed together with the main text of the print data, instead of the print header area 604.

When the preview before/after conversion switch button 605 is pressed, a preview image displayed in the preview area 601 is switched to a preview image after editing and a preview image before editing. At the same time, a display of the number of preview pages display 602 is switched accordingly.

At this time, a preview image is displayed on the printing application screen 600 in a state where the user can distinguish between the initial preview image and the latest preview image. Further, when the preview before/after conversion switch button 605 is pressed, a screen which displays a preview image before editing and a preview image after editing side-by-side may be displayed, instead of switching the images to be displayed in the preview area 601. Furthermore, the above-described display modes may be switched from one to the other.

The chat area 610 includes the chat input area 611. The chat input area 611 accepts an input of a character string in natural language from the user, and accepts a conversion instruction of print data.

The printing application 1100 transmits the accepted conversion instruction to the generative AI service 3100 together with the print data.

The printing application 1100 displays a character string describing a conversion result received from the generative AI service 3100 in the chat area 610 as a character string describing a response to the chat. In FIG. 6, text describing a user's instruction, "Delete an image of the side bar", is displayed in the chat area 610, and a conversion result describing success in deletion of the image is displayed as a response. Further, deletion of the image is an example of the layout conversion instruction, and the layout conversion instruction is not limited thereto. The layout conversion instruction can be an instruction on change of a color or a size of the image (object) or an instruction on reposition or rotation of the image (object). Similar to the instruction on deletion of the image described below, the instruction corresponding to the above-described layout conversion instruction is executed by the generative AI.

The printing application screen 600 includes other controls such as a printing execution button 620, a history display button 630, and a setting screen display button 631. When the printing execution button 620 is pressed, the printing application 1100 starts executing print job transmission processing for causing the printer 2000 to print the current print data.

When the history display button 630 is pressed, a history display screen (not illustrated) for displaying a conversion history of past print data is displayed by the printing application 1100.

When the setting screen display button 631 is pressed, a setting screen (not illustrated) is displayed by the printing application 1100. This setting screen includes controls related to printing, such as a printer selection control for selecting a printer for printing a printing target, a copy number control for specifying the number of print copies, and a color mode control for specifying a printing color, so that these settings can be performed through the setting screen. The setting screen may also include setting values related to conversion of print data executed by the generative AI server 3000.

For example, the above-described setting values include a setting value for disabling/enabling historical management of the conversion result, a setting value for disabling/enabling the processing for embedding a character string describing the instruction used for the conversion of the print data, and a setting value for disabling/enabling the processing for causing the printing application 1100 to automatically execute conversion processing by using the embedded character string describing the instruction.

A level of detail of the object selectable from the preview area 601 can be controlled by an object display slider 632. The user can change the granularity of the selectable object by sliding the object display slider 632. When an area selection toggle switch 633 is operated, a selection method of the area in the preview area 601 is switched between a selection method in object units and a selection method in optional area units.

### Example of Printing Application Screen - Object Specification

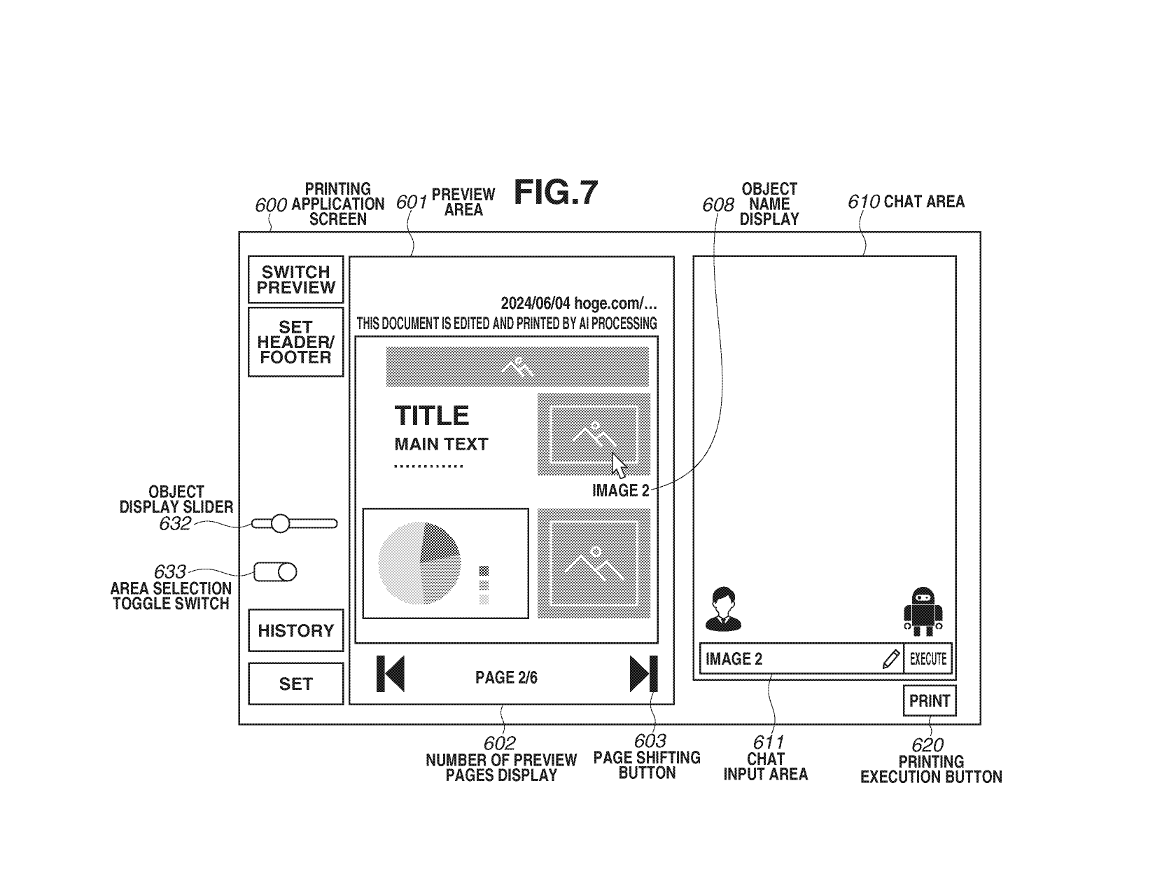

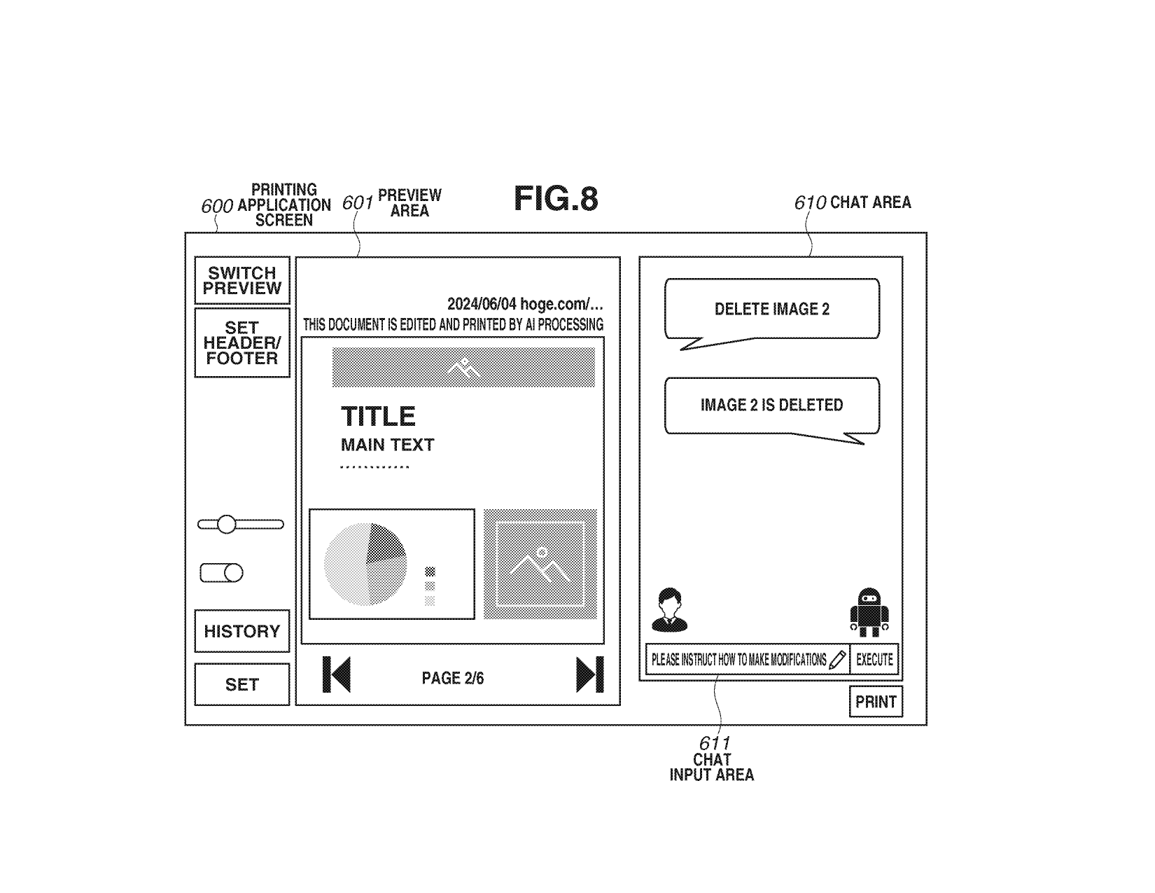

An example of a screen when the user selects an object included in the print data displayed in the preview area 601 of the printing application 1100 is described with reference to FIGS. 7 and 8. FIG. 7 illustrates a state where an object called "Image 2" is selected from the preview area 601.

An object name display 608 illustrates an example of the object name displayed when a mouse cursor is put over an image in a middle part of the preview area 601. Further, an object name "Image 2" associated with the object the user has selected from the preview area 601 is specified and input to the chat input area 611. The user can adds a character string in natural language which describes the processing to be executed on the object called "Image 2" through an operation unit such as a keyboard (not illustrated).

In FIG. 8, the user adds an editing instruction "Delete" with respect to the object called "Image 2". As described above, in a case where the print data is to be modified, the user can easily modify a modification target object by adding the details of modification after selecting the modification target object.

### Example of Printing Application Screen - Area Specification

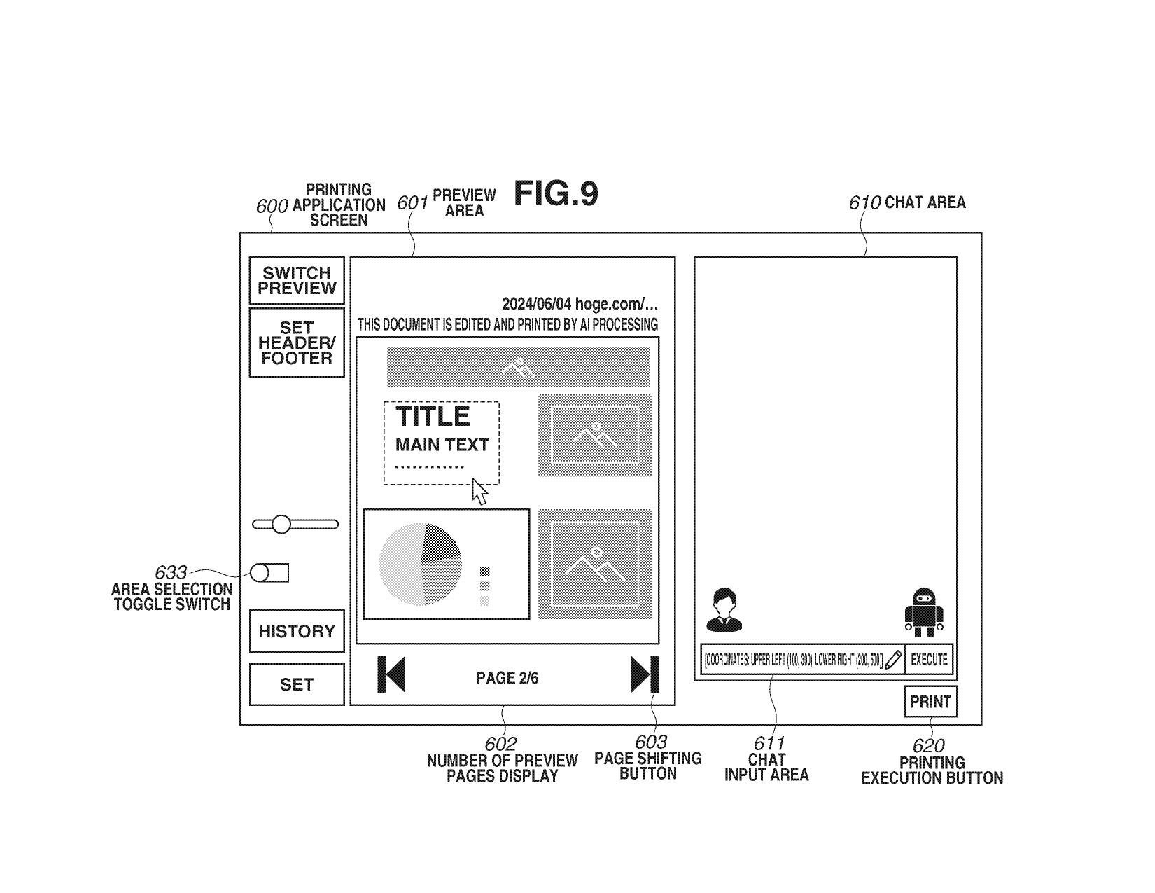

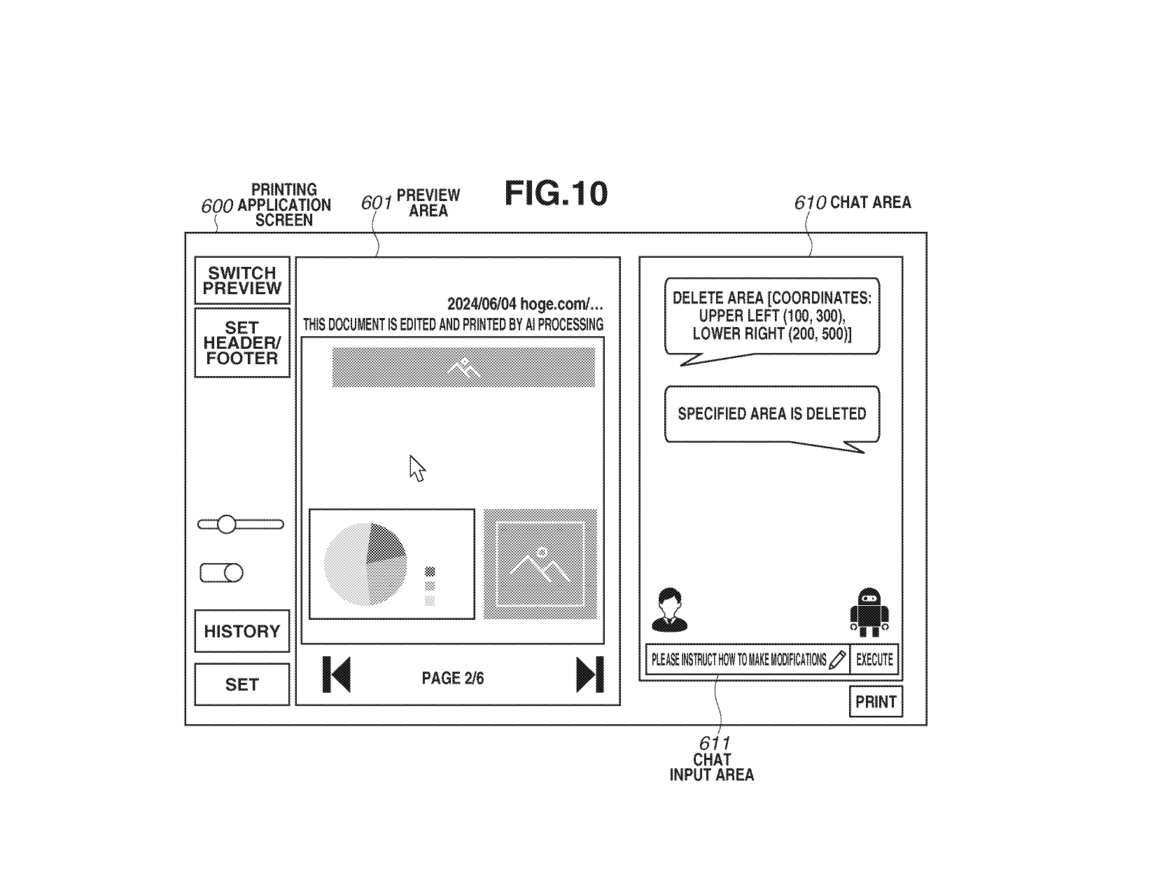

An example of a screen when the user manually selects an area in the print data displayed in the preview area 601 of the printing application 1100 is described with reference to FIGS. 9 and 10. FIG. 9 illustrates a state where the user selects an area indicated by a dotted line in the preview area 601 after setting the area selection toggle switch 633 to an area selection mode. In a case where an area is selected, coordinates indicating the area, "Coordinates: Upper Left (100, 300), Lower Right (200, 500)", are input to the chat input area 611.

The user can add a character string describing the processing to be executed on the area indicated by "Coordinates: Upper Left (100, 300), Lower Right (200, 500)" in natural language. In FIG. 10, the user adds the processing detail "Delete" with respect to the area indicated by "Coordinates: Upper Left (100, 300), Lower Right (200, 500)". As described above, the user can specify a place to be modified by specifying the area.

### Flow of Processing

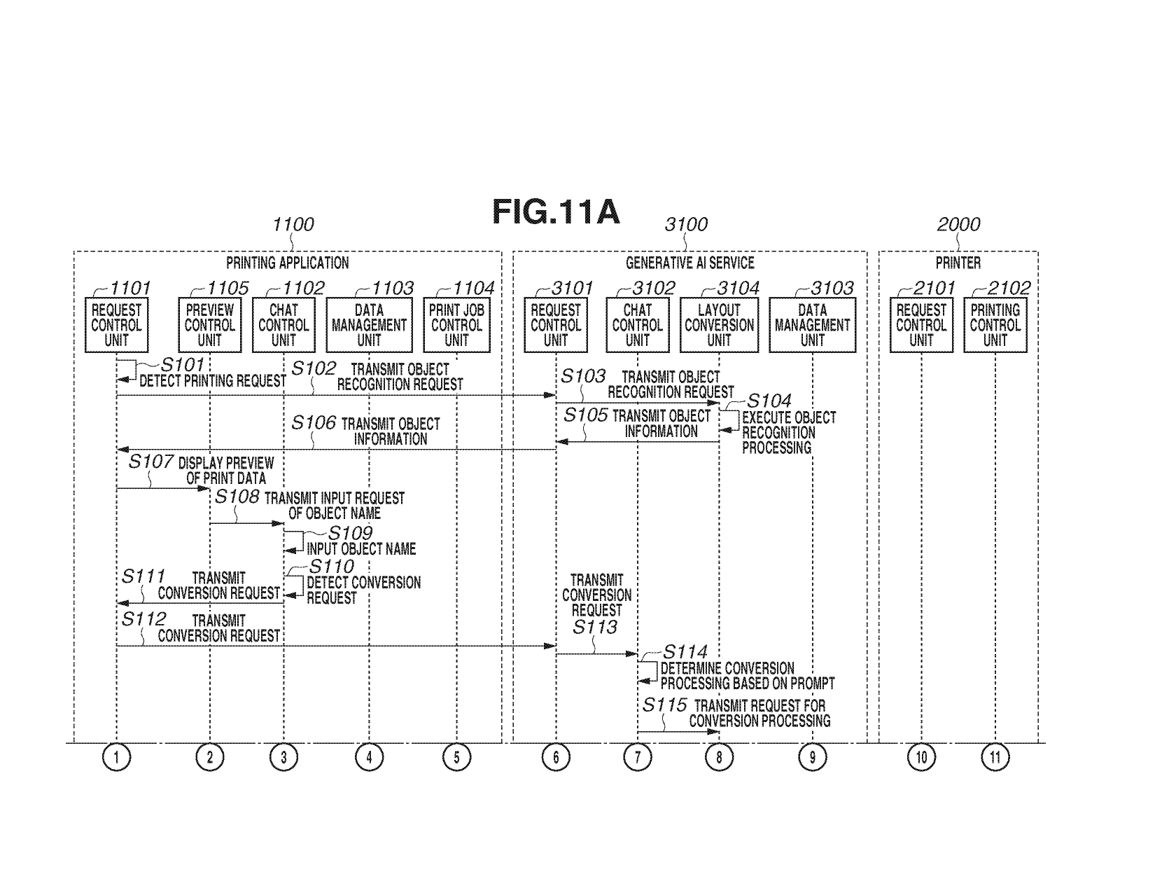

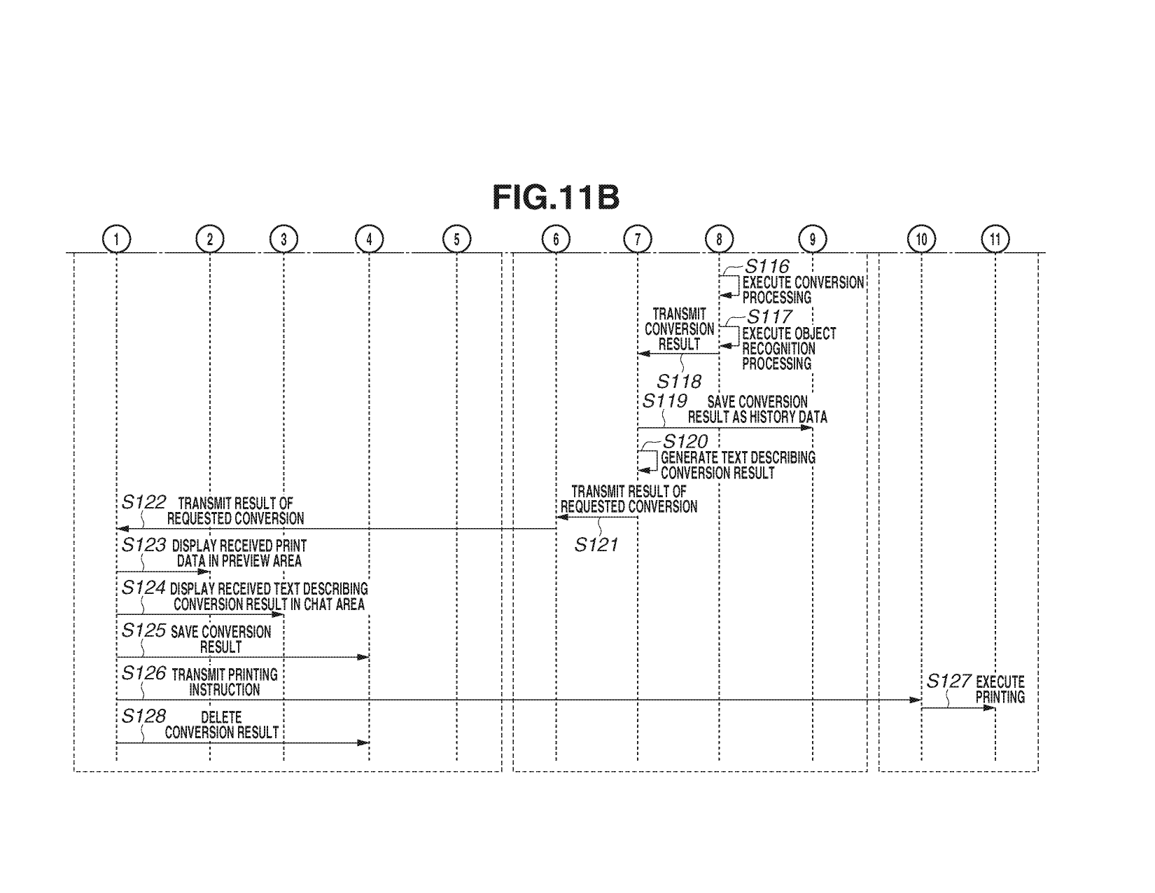

Layout conversion processing executed by the generative AI service 3100 according to the present embodiment is described with reference to the sequence diagram in FIG. 11. The processing sequentially executed by the elements constituting the computer 1000, the printer 2000, and the generative AI service 3100 is described. The below-described numbers following after a letter "S" are step numbers which indicate sequence.

As described above, the printing application 1100 may operate by being controlled by the CPU 111 of the computer 1000 or the CPU 211 of the printer 2000. In the example described below, the CPU 111 of the computer 1000 implements the function by controlling the units included in the printing application 1100.

The CPU 111 executes the following processing by controlling the request control unit 1101, the chat control unit 1102, the data management unit 1103, and the preview control unit 1105 included in the printing application 1100. Further, the CPU 311 of the generative AI server 3000 executes the following processing by controlling the request control unit 3101, the chat control unit 3102, the data management unit 3103, and the layout conversion unit 3104 included in the generative AI service 3100.

In step S101, the request control unit 1101 of the printing application 1100 detects a printing request from the computer 1000. Although the above detection is merely an example, and printing of data is not essentially required, the present embodiment is described based on the assumption that the data is printed and called "print data". Further, printing target print data is included in the printing request. In addition, the print data may be transmitted from the printer 2000 instead of the computer 1000.

In step S102, the request control unit 1101 transmits an object recognition request to the request control unit 3101 of the generative AI service 3100. The printing target print data is included in this object recognition request.

In step S103, the request control unit 3101 transmits the object recognition request to the layout conversion unit 3104. The printing target print data is included in the object recognition request.

The layout conversion unit 3104 executes object recognition processing on the received print data in step S104, and transmits the acquired object information to the request control unit 3101 in step S105.

Details of the object recognition processing is described below. Through the above-described processing, the object information about the objects (such as an image, a diagram, text, and a character string) included in the print data can be acquired. The object information includes an object type, an object name uniquely identifying the object, and area information of the object such as coordinates.

In step S106, the request control unit 3101 transmits the object information to the request control unit 1101 of the printing application 1100.

In step S107, the request control unit 1101 transmits the received print data to the preview control unit 1105 to display a preview image on an operation unit (not illustrated). Through the above-described processing, a preview image of the print data is displayed in the preview area 601 of the printing application screen 600. The object information acquired in step S106 is associated with each of the objects included in the displayed preview image.

In step S108, when the user selects an object from the preview area 601, the preview control unit 1105 transmits an input request of the object name associated with the selected object to the chat control unit 1102 of the printing application 1100. In other words, the preview control unit 1105 accepts selection of the object included in the data from the user. The object name associated with the selected object is included in the input request of the object name.

In a case where an area is selected by the user, an input request including the coordinates associated with the selected area is transmitted. Through the above-described processing, a name or coordinates of the object is displayed in the chat input area 611.

In step S109, the chat control unit 1102 inputs the object name or the coordinates received from the preview control unit 1105 in step S108 to the chat input area 611. In other words, when the user selects the object, selection of the object is accepted, a character string in natural language associated with the object is specified, and the specified character string is displayed in the chat input area 611.

In step S110, the chat control unit 1102 detects a conversion request input by the user. Specifically, the chat control unit 1102 detects a character string in natural language input to the chat input area 611 by the user, in addition to the object name or the coordinates displayed in the chat input area 611 in step S108. In other words, the chat control unit 1102 accepts a character string in natural language input by the user.

In step S111, when an execution button included in the chat input area 611 is pressed, the chat control unit 1102 transmits a conversion request to the request control unit 1101. The conversion request is an instruction to the generative AI, which consists of a character string in natural language associated with the object or the area selected by the user and a character string in natural language accepted by being input to the chat input area 611. In the present embodiment, the conversion request further includes print data when necessary. In addition, the execution button can be a transmission button or a submission button.

In step S112, the request control unit 1101 transmits the conversion request to the request control unit 3101 of the generative AI service 3100. In other words, the request control unit 1101 transmits a character string in natural language associated with the selected object or the selected area, a character string in natural language accepted by being input to the chat input area 611 by the user, and the print data to the generative AI service 3100 included in the generative AI server 3000.

In step S113, the request control unit 3101 transmits the conversion request to the chat control unit 3102.

In step S114, the chat control unit 3102 interprets the received conversion request described in natural language and the received print data, and determines the layout conversion processing to be executed on the print data based on the interpretation.

In step S115, the chat control unit 3102 transmits a request for the layout conversion processing determined in step S114 to the layout conversion unit 3104.

In step S116, the layout conversion unit 3104 executes the layout conversion processing included in the layout conversion request on the print data included in the layout conversion request. In this case, the layout conversion processing is executed by using the object information acquired in step S104. Specifically, according to the conversion request, the layout conversion unit 3104 executes the specified processing on the object or the area corresponding to the conversion request, included in the received print data.

In step S117, the layout conversion unit 3104 executes the object recognition processing on the conversion result.

A method different from the method used in step S104 can be used for the object recognition processing. For example, the object recognition processing using generative AI may be executed when print data is a web page. As described above, the method may be changed depending on a format of print data.

In step S118, the layout conversion unit 3104 returns the conversion result to the chat control unit 3102. At this time, the print data after conversion and the object information are included in the conversion result.

In step S119, the chat control unit 3102 saves the information before/after conversion in the data management unit 3103 as history data. An example of the saved history data is illustrated in FIG. 14.

In step S120, based on the conversion result received in step S118, the chat control unit 3102 generates text describing a conversion result indicating success or failure in conversion.

In step S121, the chat control unit 3102 returns a result of the requested conversion to the request control unit 3101. In step S122, the request control unit 3101 returns the result of the requested conversion to the request control unit 1101 of the printing application 1100. The print data after conversion and its object information returned from the layout conversion unit 3104 in step S118 and the text describing the conversion result generated in step S120 are included in the result of the requested conversion.

In step S123, the request control unit 1101 transmits the print data included in the received result of the requested conversion to the preview control unit 1105 to display a preview image on the operation unit (not illustrated). Through the above-described processing, a preview image of the print data including the object processed by the conversion (editing) processing is displayed in the preview area 601 of the printing application screen 600. The object information acquired in step S117 is included in each of the objects included in the displayed preview image.

In step S124, the request control unit 1101 transmits the text describing the conversion result included in the received result of the requested conversion to the chat control unit 1102 to display the text in the chat area 610.

In step S125, the request control unit 1101 saves the received conversion result in the data management unit 1103 of the printing application 1100. After that, it is possible to generate print data in a layout desired by the user by repeatedly executing the processing in steps S108 to S125 for the optional number of times. In addition, repeating the above-described processing is not essentially required, and the processing may be executed just one time.

In the present embodiment, the print data is transmitted every time. However, the print data does not have to be transmitted every time. In this case, the print data transmitted in step S102 is saved in the data management unit 3103 of the generative AI service 3100. Then, from the second time onward, the conversion processing in step S116 may be executed by using the latest print data after conversion, saved in the data management unit 3103. Through the above-described configuration, the communication volume can be reduced, so that it is possible to reduce the economic burden of the user who uses a generative AI service whose charges are normally calculated based on the amount of data transmission.

The user inputs a printing execution instruction when the print data expected by the user is generated through the conversion processing using the generative AI. In step S126, the request control unit 1101 detects the printing execution instruction input by the user, and transmits the printing execution instruction and the print data to the request control unit 2101 of the printer 2000.

In step S127, according to the control executed by the CPU 211 of the printer 2000, the request control unit 2101 executes printing through the printing control unit 2102. Through the above-described processing, the print data processed by the generative AI can be printed.

In step S128, the request control unit 1101 of the printing application 1100 deletes the unnecessary conversion result from the data management unit 1103. In addition, this processing is not essentially required.

By executing the above-described processing, the user can easily instruct the generative AI to edit data by expressing the editing target with a character string in natural language by selecting the object included in the displayed preview image.

### Object Recognition Processing

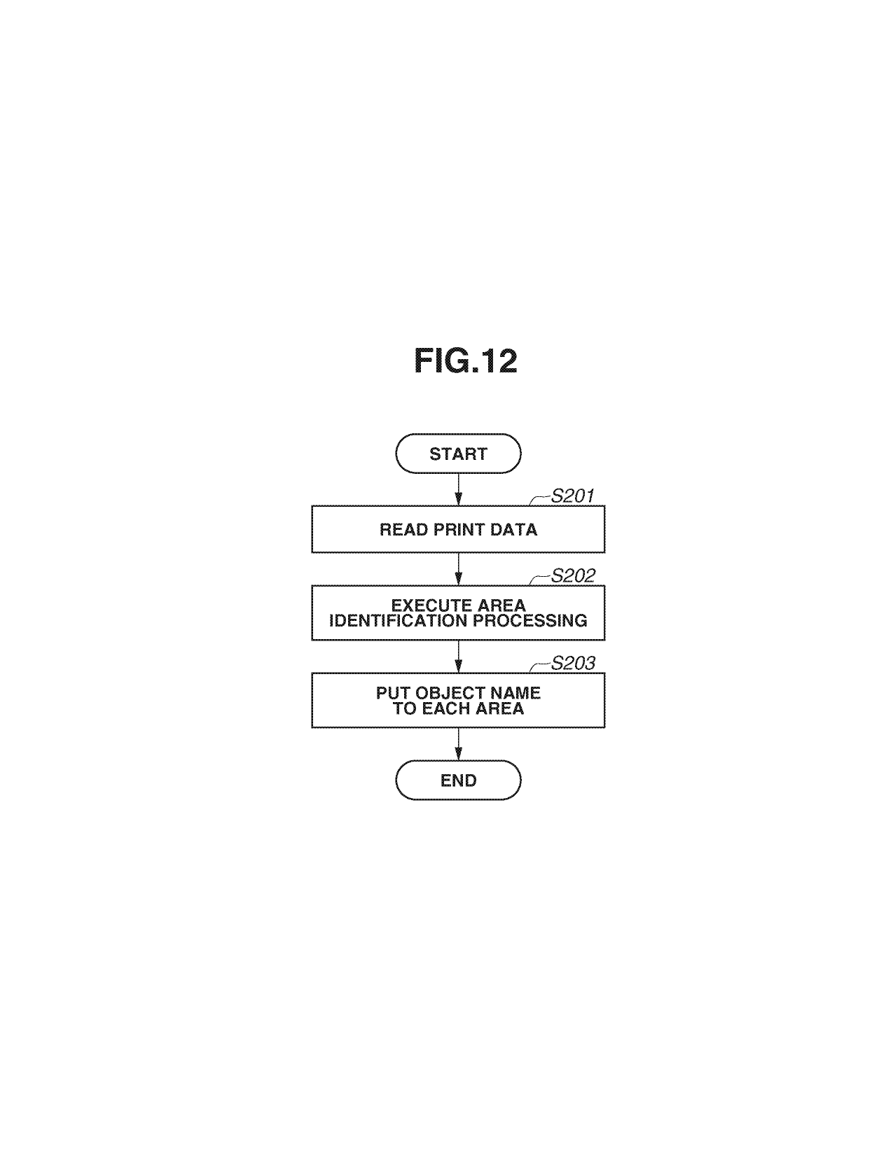

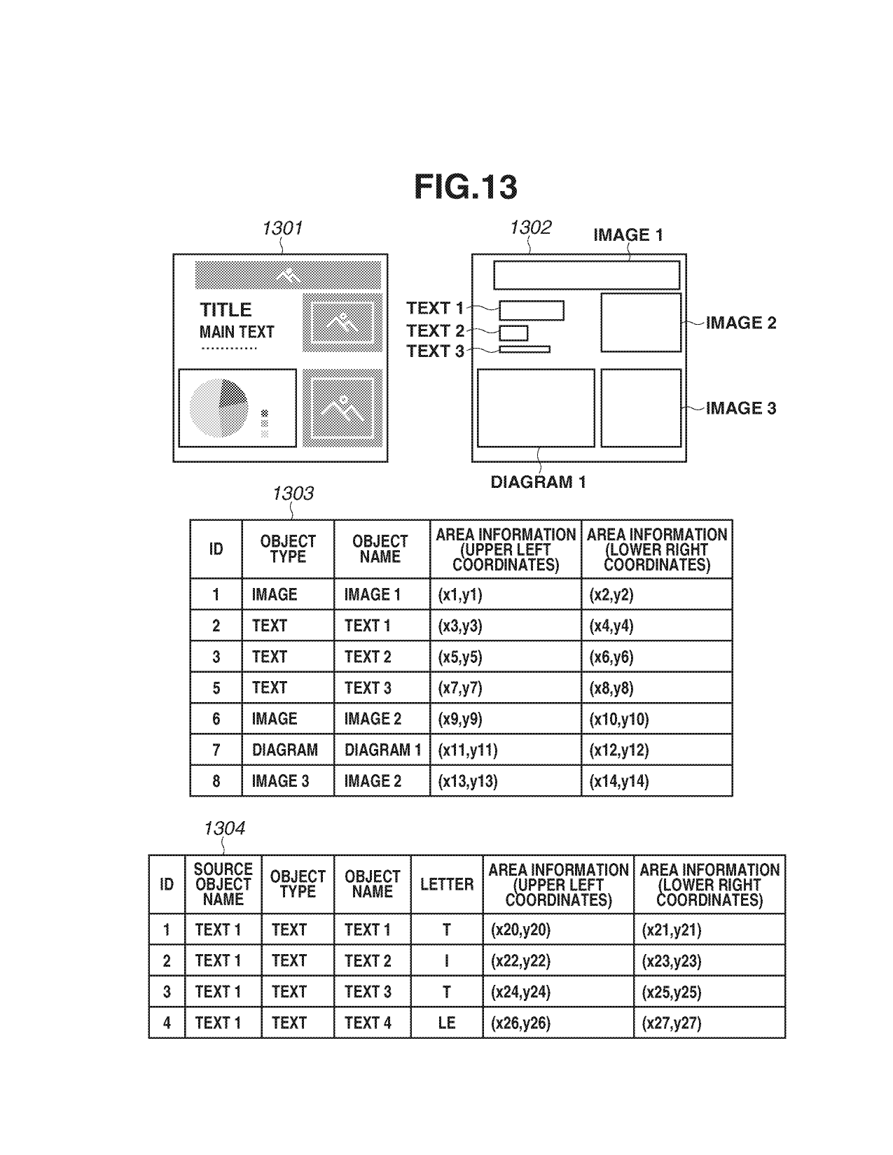

A flow of object recognition processing executed on the print data and a result of the processing are described with reference to FIGS. 12 and 13. The below-described numbers following after a letter "S" are step numbers in the flowchart. This processing is executed by the CPU 311 of the generative AI server 3000 by controlling the units, and the processing is started when the print data is transmitted to the generative AI server 3000.

First, in step S201, the CPU 311 reads the print data received from the request control unit 3101. Herein, the processing executed on image data is described as an example, although print data in various formats, such as image data and a web page, can be considered as the above-described print data. An image 1301 in FIG. 13 illustrates an example of read image data.

Next, in step S202, the CPU 311 executes area identification processing (object recognition processing) on the read image 1301. For example, the area identification processing is executed through the image area separation processing described in Japanese Patent Laid-Open No. 2011-76575 and/or the area identification processing described in Japanese Patent Laid-Open No. 2003-30584. Through the above-described processing, information about a type and coordinates of each of areas in the image 1301 can be acquired. An identification result 1302 in FIG. 13 illustrates a result of the area identification processing.

Next, in step S203, the CPU 311 puts a unique object name to each of pieces of the area information acquired in step S202. In this way, each area can be identified by the object name.

A table 1303 in FIG. 13 illustrates examples of the object information acquired by the above-described series of processes. Further, by executing character recognition processing on the area identified as the object type "Text", information about each character included in the area may be acquired and included in the object information. A table 1304 in FIG. 13 illustrates examples of information about characters included in the area having the object name "Text 1".

Although the processing executed on image data is described as an example, similar information can also be acquired through an extraction method of structured documents described in Japanese Patent Laid-Open No. 2014-81945, in a case where the print data is a web page.

Further, as another method for acquiring the above-described object information, a method for acquiring the object information by inputting print data and processing details (i.e., implementing the area identification processing to output the information about a type and coordinates of each area) to the generative AI may be used regardless of the format of print data.

### Structure of History Data

A structure of history data saved in the data management unit 3103 of the generative AI service 3100 is described with reference to FIG. 14. A history data database (DB) 300 includes a prompt 301, data before conversion 302, data after conversion 303, object data before conversion 304, object data after conversion 305, a job identifier 306, and date/time 307 as items of history data.

Each row of the history data DB 300 illustrates a piece of history data. The prompt 301 is a prompt the generative AI service 3100 has received as a conversion request. The data before conversion 302 is print data before conversion processing is executed based on the prompt 301. The data after conversion 303 is print data after conversion processing is executed by the generative AI service 3100 based on the prompt 301.

The object data before conversion 304 is object information acquired when the object recognition processing is executed before the conversion processing is executed. The object data after conversion 305 is object information acquired when the object recognition processing is executed after the conversion processing is executed.

The data before and after conversion may be saved in the external storage, instead of being directly saved in the history data DB 300. Then, information such as a URL, which specifies a file saved in the external storage, may be saved in the history data DB 300. For example, a file name of a printing target or a URL of the printing target is saved as the job identifier 306. The date/time 307 is a date and time when conversion is executed based on the prompt 301.

The information saved in the history data DB 300 may be deleted when target print data is printed. In addition, the information may be retained without being deleted even if the print data has already been printed.

As described above, the printing system according to the present disclosure executes object recognition processing on print data to make objects selectable from the preview area. When an object is selected, an object name uniquely identifying the object is automatically input to the chat input area, and an instruction from the user can also be input thereto. In this way, printing can be executed after the print data is modified according to an appropriate instruction in natural language, input through a chat.

In addition, in the present embodiment, the user can specify a plurality of objects or areas. Further, in a case where the user performs mouseover to acquire identification information for identifying the object such as the object name, the user may issue a conversion instruction to the generative AI service 3100 by inputting the acquired identification information with a character string in natural language, without selecting the object.

In the present embodiment, as described in FIG. 8, the object name "Image 2" is input when the user selects the object, and a character string which describes an instruction "Delete" in natural language is input by the user. Through the above-described processing, the generative AI service 3100 executes the processing based on the instruction "Delete" on the object associated with the object name "Image 2".

However, there is a case where the user would like to execute this processing on an object called "Image 1" in addition to the object called "Image 2". In this case, the object name "Image 2" is input when the user selects the object, and a character string which describes an instruction "Delete Image 1 together with..." in natural language is input by the user. In this case, the generative AI service 3100 interprets the prompt through the processing executed in step S114, and executes the processing based on the instruction "Delete" on the objects associated with the object names "Image 1" and "Image 2".

In the present embodiment, although the print data is transmitted to the generative AI server 3000 from the computer 1000, the present embodiment is not limited thereto. For example, image data read and acquired by the scanner included in the printer 2000 may be transmitted to the generative AI server 3000 from the printer 2000.

In this case, the printer 2000 and the computer 1000 log in to the account of the generative AI service 3100 by using the same authentication information. Then, the image data acquired by the printer 2000 is transmitted to the generative AI server 3000 together with the account information. Subsequently, the computer 1000 logs in to the generative AI service 3100 with the same account information, so that the user can check a preview image of the image data through the computer 1000. In this way, the user can acquire desired print data by executing the above-described processing after checking the image data acquired by the printer 2000 through the computer 1000.

Further, in a case where the printing application 1100 operates by being controlled by the CPU 211 of the printer 2000, the present system can be implemented by only the printer 2000 and the generative AI server 3000 without using the computer 1000.

Further, although the object recognition processing is executed by the generative AI server 3000, the present embodiment is not limited thereto. The object recognition processing may be executed by the computer 1000 or the printer 2000 which transmits the print data to the generative AI server 3000, and the object information may be transmitted to the generative AI server 3000 together with the print data.

Further, in the present disclosure, "generative AI" refers to a technique for automatically generating various types of content similar to the content created by humans, such as text, an image, music, and video, by using a deep learning method and a machine learning method.

Further, in the printing system according to the present embodiment, there is a case where a server such as the generative AI server 3000 is present outside of Japan, and a terminal apparatus such as the computer 1000 (hereinafter, called "terminal apparatus") is present in Japan. Even in the above-described situation, files and data are transmitted to the terminal apparatus from the server, and the terminal apparatus can receive the files and the data.

As described above, even if the server is present outside of Japan, transmission and reception (transmission-reception) of files and data in the present system are executed in an integrated manner. Then, in view of the fact that the system becomes functional when the terminal apparatus present in Japan receives the files and data, this transmission-reception can be considered as domestic transmission-reception.

In the present system, for example, even in a case where the server is present outside of Japan whereas the terminal apparatus is present in Japan, the terminal apparatus can implement a main function of the present system, so that it is possible to exert an effect achieved by the function in Japan. For example, even in a case where the server is present outside of Japan, the user can use the system in Japan by using the terminal apparatus as long as the terminal apparatus which constitutes the system is present in Japan. Therefore, use of the system brings an economical benefit to a patent owner.

### Other Embodiments

The present disclosure can also be realized through processing in which a program for implementing one or more functions according to the above-described embodiments is supplied to a system or an apparatus via a network or a storage medium, and one or more processors in a computer included in the system or the apparatus read and execute the program. Further, the present disclosure can also be realized with a circuit (e.g., application specific integrated circuit (ASIC)) which implements one or more functions.

According to the present disclosure, it is possible to easily instruct the generative AI to edit data by expressing an editing target with a character string in natural language.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-186259, filed October 22, 2024, which is hereby incorporated by reference herein in its entirety.

What is claimed is:

1. A non-transitory computer-readable storage medium for storing a computer program that, when executed by one or more processors of an information processing apparatus causes the information processing apparatus to execute a method comprising:
displaying identification information associated with an object when the object included in data is selected by a user; and
accepting a character string in natural language from the user,
wherein processing based on a prompt including the identification information and the accepted character string in natural language is executed on the selected object by generative artificial intelligence (AI).

2. The non-transitory computer-readable storage medium according to claim 1, wherein the method to be executed further comprises displaying, the object on which the processing is executed by the generative AI.

3. The non-transitory computer-readable storage medium according to claim 1, wherein the method to be executed further comprises:
receiving the identification information acquired by inputting the data to the generative AI; and
displaying the identification information associated with the object included in the data that is specified based on the received identification information.

4. The non-transitory computer-readable storage medium according to claim 1, wherein the method to be executed further comprises:
recognizing the object included in the data, and associating the identification information with the recognized object; and
displaying the identification information associated with the object included in the data based on the associated identification information.

5. The non-transitory computer-readable storage medium according to claim 1, wherein the object is an image, and the data is image data including the image.

6. The non-transitory computer-readable storage medium according to claim 1, wherein the object is a character string, and the data is image data including the character string.

7. The non-transitory computer-readable storage medium according to claim 1, wherein the identification information associated with the object is a character string in natural language associated with the object.

8. The non-transitory computer-readable storage medium according to claim 7, wherein the character string in natural language associated with the object is a name of the object.

9. The non-transitory computer-readable storage medium according to claim 1, wherein the method to be executed further comprises displaying the identification information in an input column where a character string in natural language to be input to the generative AI is input.

10. The non-transitory computer-readable storage medium according to claim 9, wherein the method to be executed further comprises, displaying an object including the input column and a preview image of the data.

11. The non-transitory computer-readable storage medium according to claim 1, wherein the character string in natural language is a character string for instructing details of processing to be executed on the selected object.

12. A non-transitory computer-readable storage medium for storing a computer program that, when executed by one or more processors of an information processing apparatus causes the information processing apparatus to execute a method comprising:
displaying identification information associated with an area when the area included in data is selected by a user; and
accepting a character string in natural language from the user,
wherein processing based on a prompt including the identification information and the accepted character string in natural language is executed on the selected area by generative AI.

13. The non-transitory computer-readable storage medium according to claim 12, wherein the method to be executed further comprises displaying, an object included in the area on which the processing is executed by the generative AI.

14. The non-transitory computer-readable storage medium according to claim 12, wherein the method to be executed further comprises:
receiving the identification information acquired by inputting the data and the selected area to the generative AI; and
displaying the identification information associated with the selected area included in the data based on the received identification information.

15. The non-transitory computer-readable storage medium according to claim 12, wherein the method to be executed further comprises:
recognizing the area selected by the user, and associating the identification information with the recognized area; and
displaying the identification information associated with the selected area included in the data based on the associated identification information.

16. The non-transitory computer-readable storage medium according to claim 12, wherein the area is an area in an image described in the data.

17. The non-transitory computer-readable storage medium according to claim 12, wherein the method to be executed further comprises displaying the identification information in an input column where a character string in natural language to be input to the generative AI is input.

18. The non-transitory computer-readable storage medium according to claim 17, wherein the method to be executed further comprises displaying an object including the input column and a preview image of the data.

19. The non-transitory computer-readable storage medium according to claim 12, wherein the character string in natural language is a character string for instructing details of processing to be executed on the selected area.

20. An information processing apparatus comprising:
one or more memories storing a program; and
one or more processors that, upon execution of the stored program, cause the one or more processors to operate as:
a display unit configured to display identification information associated with an object when the object included in data is selected by a user; and
an acceptance unit configured to accept a character string in natural language from the user,
wherein processing based on a prompt including the identification information and the accepted character string in natural language is executed on the selected object by generative AI.
